(19) United States
(12) Patent Application Publication
(10) Pub. No.: US 2016/0138702 A1
(43) Pub. Date: May 19, 2016

(54) DIFFERENTIAL DEVICE

(71) Applicant: MUSASHI SEIMITSU INDUSTRY CO., LTD., TOYOHASHI-SHI (JP)

(72) Inventors: Yoichi YANASE, TOYOHASHI-SHI (JP); Hiroyuki MORI, TOYOHASHI-SHI (JP)

(21) Appl. No.: 14/943,218

(22) Filed: Nov. 17, 2015

(30) Foreign Application Priority Data
Nov. 18, 2014 (JP) 2014-233740
Oct. 7, 2015 (JP) 2015-199797
Oct. 26, 2015 (JP) 2015-210184

(51) Int. Cl. F16H 57/04; F16H 48/08

(52) U.S. Cl. CPC F16H 57/0431; F16H 48/08; F16H 57/0483; F16H 57/0479

(57) ABSTRACT

In a differential device, even in a case where tooth portions of side gears are placed farther from output shafts, or in a case of high-speed rotation of a pinion, lubricant oil can be sufficiently supplied from the output shaft sides to meshing portions of the pinion and the side gears and sliding portions of the pinion. Accordingly, seizure in the meshing portions and the sliding portions is prevented effectively. At least one of the side gears includes a lubricant oil passage in a shaft portion and a lubricant oil groove in an inner side surface facing the other side gear, the lubricant oil passage guiding the lubricant oil from an outer end portion to an inner end portion in an axial direction of the shaft portion, and the lubricant oil groove being configured to supply the lubricant oil from the lubricant oil passage to the tooth portion side.

### BACKGROUND OF THE INVENTION

1. Field of the Invention

The present invention relates to a differential device, particularly the differential device which distributively transmits rotational force of an input member to a pair of output shafts via a pair of side gears (i.e., output gears), the input member retaining a pinion support portion (i.e., a differential gear support portion) that supports a pinion (i.e., a differential gear) and being rotatable together with the pinion support portion.

2. Description of the Related Art

Such differential devices have been publicly known as described in Japanese Patent Application KOKAI Publication No. 2008-89147, for example. The conventional differential device is configured to supply lubricant oil to sliding portions of pinions and meshing portions of the pinions and side gears via gaps between back surfaces of the side gears and a differential case, and via spline-fitting portions between inner peripheries of the side gears and outer peripheries of the output shafts.

However, the conventional differential device cannot efficiently supply a large amount of lubricant oil to the meshing portions of the pinions and the side gears. For this reason, the sliding portions of the pinions and the meshing portions of the pinions and the side gears are likely to have shortage of lubricant oil supply, for example in a case where the meshing portions are placed farther from the output shafts due to an increase in the diameter of the side gears, or under severe driving conditions such as high-speed rotation of the pinions.

### SUMMARY OF THE INVENTION

The present invention has been made with the foregoing situation taken into consideration. An object of the present invention is to provide a differential device capable of solving the above-mentioned problem.

In order to achieve the object, a differential device according to the present invention, distributively transmits rotational force of an input member to a pair of output shafts via a pair of side gears, the input member retaining a pinion support portion that supports a pinion and being rotatable together with the pinion support portion, wherein the pair of side gears each include a tooth portion provided in an outer peripheral portion and meshing with the pinion, and a shaft portion provided in an inner peripheral portion and connected to the corresponding output shaft, and at least one of the side gears includes a lubricant oil passage in the shaft portion, the lubricant oil passage guiding lubricant oil from an outer end portion to an inner end portion in an axial direction of the shaft portion, and a lubricant oil groove in an inner side surface facing the other side gear, the lubricant oil groove being configured to supply the lubricant oil from the lubricant oil passage to the tooth portion side. (This is a first characteristic of the present invention.)

According to the first characteristic, at least one of the side gears includes the lubricant oil passage in the shaft portion and the lubricant oil groove in the inner side surface facing the other side gear, the lubricant oil passage guiding the lubricant oil from the outer end portion to the inner end portion in the axial direction of the shaft portion, and the lubricant oil groove being configured to supply the lubricant oil from the lubricant oil passage to the tooth portion side. Thus, the lubricant oil flowing in the lubricant oil passage can be efficiently supplied to the tooth portion of the side gear via the lubricant oil groove in the inner side surface of the side gear by using centrifugal force of rotation of the input member. Thereby, even in a case where the tooth portions of the side gears are placed farther from the output shafts due to an increase in a diameter of the side gears, or even under severe driving conditions such as high-speed rotation of the pinion, the lubricant oil can be sufficiently supplied from the output shaft sides to meshing portions of the pinion and the side gears and sliding portions of the pinion. Accordingly, seizure in the meshing portions and the sliding portions can be prevented effectively.

In the differential device according to the present invention, preferably, the pair of side gears each include a flat intermediate wall portion integrally connecting the shaft portion and the tooth portion separated outward from the shaft portion in a radial direction of the input member, and at least one of the side gears includes the lubricant oil groove in an inner side surface of the intermediate wall portion. (This is a second characteristic of the present invention.)

According to the second characteristic, the pair of side gears each include the flat intermediate wall portion integrally connecting the shaft portion and the tooth portion separated outward from the shaft portion in the radial direction of the input member, and at least one of the side gears includes the lubricant oil groove in the inner side surface of the intermediate wall portion. Thus, the diameter of each side gear can be made sufficiently larger than the diameter of the pinion, so that the number of teeth of the side gear can be made sufficiently larger than the number of teeth of the pinion. This makes it possible to reduce load burden on the pinion support portion applied in torque transmission from the pinion to the side gears, and thus to decrease an effective diameter of the pinion support portion, and accordingly decrease a width of the pinion in the axial direction. In cooperation with an effect of the flatness of the intermediate wall portions, the aforementioned decrease can contribute to a decrease in the width of the differential device in the axial direction. Furthermore, even in the case where the tooth portions of the side gears are placed farther from the output shafts in the radial direction due to an increase in the diameter of the side gears, the lubricant oil can be sufficiently supplied from the output shaft sides to the tooth portions, accordingly the meshing portions and the sliding portions, through the lubricant oil groove specially provided to the inner side surface of the intermediate wall portion.

In the differential device according to the present invention, preferably, the lubricant oil groove includes a straight groove portion extending straight, and a guide groove portion continuous to an outer end of the straight groove portion in the radial direction, and a bottom surface of the guide groove portion inclines relative to a bottom surface of the straight groove portion. (This is a third characteristic of the present invention.)

According to the third characteristic, the lubricant oil groove includes the straight groove portion extending straight, and the guide groove portion continuous to the outer end of the straight groove portion in the radial direction, and the bottom surface of the guide groove portion inclines relative to the bottom surface of the straight groove portion. This configuration allows the lubricant oil to flow smoothly from the guide groove portion toward the tooth portion side of the corresponding side gear, after the lubricant oil flows straight through the straight groove portion of the lubricant oil groove. Accordingly, the effect of lubricating the meshing portions and the sliding portions can be enhanced more.

In the differential device according to the present invention, preferably, the pinion support portion includes a cutout surface in an outer peripheral surface, at least part of the cutout surface facing an inner peripheral surface of the pinion, and the guide groove portion and the part of the cutout surface are situated on a same circumference around an axis of the output shafts as seen in a projection plane orthogonal to the axis. (This is a fourth characteristic of the present invention.)

According to the fourth characteristic, the pinion support portion includes the cutout surface in the outer peripheral surface, at least part of the cutout surface facing the inner peripheral surface of the pinion, and the guide groove portion and the part of the cutout surface are situated on the same circumference around the axis of the output shafts as seen in the projection plane orthogonal to the axis. Thus, by use of rotational force of the differential mechanism, the lubricant oil can be efficiently supplied to a lubricant oil reservoir (i.e., a gap part facing the cutout surface) between fitting surfaces of the pinion and the pinion support portion, which tend to seize up due to their high-speed rotation.

In addition, in order to achieve the object, a differential device according to the present invention, distributively transmits rotational force of an input member to a pair of output shafts via a pair of output gears, the input member retaining a differential gear support portion that supports a differential gear and being rotatable together with the differential gear support portion, wherein the pair of output gears each include a tooth portion provided in an outer peripheral portion and meshing with the differential gear, and a shaft portion provided in an inner peripheral portion and connected to the corresponding output shaft, and at least one of the output gears includes a lubricant oil passage in the shaft portion, the lubricant oil passage guiding lubricant oil from an outer end portion to an inner end portion in an axial direction of the shaft portion, and a lubricant oil groove in an inner side surface facing the other output gear, the lubricant oil groove being configured to supply the lubricant oil from the lubricant oil passage to the tooth portion side, wherein

$$d 2 / P C D ≦ 3.36 \cdot {( \frac{1}{z 1} )}^{\frac{2}{3}} \cdot sin ( {tan}^{- 1} \frac{z 1}{z 2} )$$

is satisfied, and

Z1/Z2>2 is satisfied, where Z1, Z2, d2 and PCD denote the number of teeth of each of the output gears, the number of teeth of the differential gear, a diameter of the differential gear support portion and a pitch cone distance, respectively. (This is a fifth characteristic of the present invention.)

According to the fifth characteristic, at least one of the output gears includes the lubricant oil passage in the shaft portion and the lubricant oil groove in the inner side surface facing the other output gear, the lubricant oil passage guiding lubricant oil from the outer end portion to the inner end portion in the axial direction of the shaft portion, and the lubricant oil groove being configured to supply the lubricant oil from the lubricant oil passage to the tooth portion side. Thus, the lubricant oil flowing in the lubricant oil passage can be efficiently supplied to the tooth portion of the output gear via the lubricant oil groove in the inner side surface of the output gear by using centrifugal force of rotation of the input member. Thereby, even in a case where the tooth portions of the output gears are placed farther from the output shafts due to an increase in a diameter of the output gears, or even under severe driving conditions such as high-speed rotation of the differential gear, the lubricant oil can be sufficiently supplied from the output shaft sides to meshing portions of the differential gear and the output gears and sliding portions of the differential gear. Therefore, seizure in the meshing portions and the sliding portions can be prevented effectively. Moreover, according to the fifth characteristic, the differential device as a whole can be sufficiently reduced in width in the axial direction of the output shafts while securing the strength (for example, the static torsion load strength) and the maximum amount of torque transmission at approximately the same levels as the conventional differential device. Accordingly, the differential device can be easily incorporated in a transmission system, which is under many layout restrictions around the differential device, with great freedom and no specific difficulties, and is therefore advantageous in reducing the size of the transmission system.

In the differential device according to the present invention, preferably, Z1/Z2≧4 is satisfied. (This is a sixth characteristic of the present invention.)

In the differential device according to the present invention, preferably, Z1/Z2≧5.8 is satisfied. (This is a seventh characteristic of the present invention.)

According to the sixth and seventh characteristics, the differential device can be more sufficiently reduced in width in the axial direction of the output shafts while securing the strength (for example, the static torsion load strength) and the maximum amount of torque transmission at approximately the same levels as the conventional differential device.

The above and other objects, characteristics and advantages of the present invention will be clear from detailed descriptions of the preferred embodiments which will be provided below while referring to the attached drawings.

### BRIEF DESCRIPTION OF THE DRAWINGS

FIG. 1 is a longitudinal sectional view of a differential device and its vicinity of an embodiment of the present invention (a sectional view taken along a 1-1 line in FIG. 2).

FIG. 2 is a partially cutaway side view of the differential device (a sectional view taken along a 2-2 line in FIG. 1).

FIG. 3 is a sectional view taken along a 3-3 line in FIG. 1.

FIG. 4 is a sectional view taken along a 4-4 line in FIG. 1 with only a side gear represented with solid lines.

FIG. 5A is an enlarged view of a part indicated with an arrow 5 in FIG. 1, and FIG. 5B is a sectional view taken along a B-B line of FIG. 5A.

FIG. 6 is a partial sectional view showing a modified embodiment of a differential gear support portion in the differential device and corresponding to FIG. 5A.

FIG. 7 is a longitudinal sectional view showing an example of a conventional differential device.

FIG. 8 is a graph showing a relationship of gear strength change rates with a number-of-teeth ratio where the number of teeth of the pinion is set at 10.

FIG. 9 is a graph showing a relationship of the gear strength change rates with a pitch cone distance change rate.

FIG. 10 is a graph showing a relationship of the pitch cone distance change rate with the number-of-teeth ratio for keeping 100% of the gear strength where the number of teeth of the pinion is set at 10.

FIG. 11 is a graph showing a relationship between a shaft diameter/pitch cone distance ratio and the number-of-teeth ratio where the number of teeth of the pinion is set at 10.

FIG. 12 is a graph showing a relationship between the shaft diameter/pitch cone distance ratio and the number-of-teeth ratio where the number of teeth of the pinion is set at 6.

FIG. 13 is a graph showing a relationship between the shaft diameter/pitch cone distance ratio and the number-of-teeth ratio where the number of teeth of the pinion is set at 12.

FIG. 14 is a graph showing a relationship between the shaft diameter/pitch cone distance ratio and the number-of-teeth ratio where the number of teeth of the pinion is set at 20.

### DESCRIPTION OF THE PREFERRED EMBODIMENTS

Embodiments of the present invention will be described below based on the drawings.

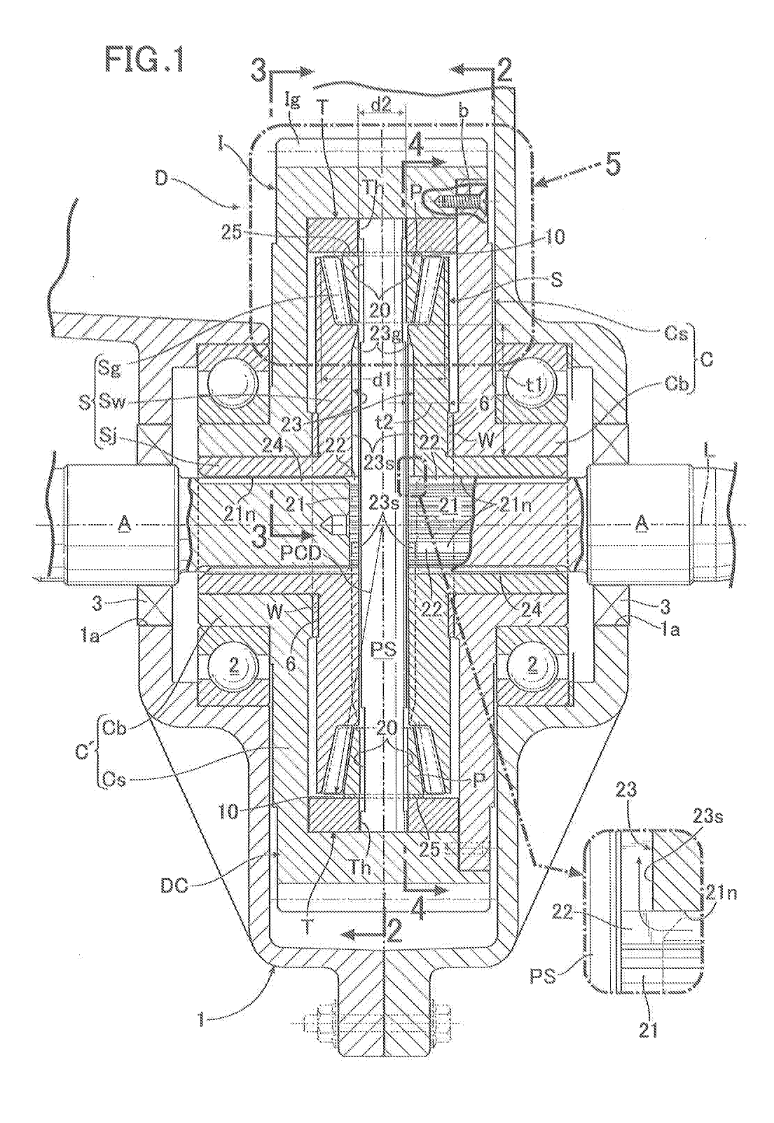

To begin with, in FIGS. 1 to 3, a differential device D drives a pair of left and right axles while allowing differential rotation thereof, by distributively transmitting rotational driving force, which is transmitted from an engine (not illustrated) mounted on an automobile, to a pair of left and right output shafts A continuous to the left and right axles. The differential device D is housed and supported, for example, inside a transmission case 1 disposed beside the engine in a front portion of a vehicle body.

The differential device D includes: a plurality of pinions (differential gears) P; a pinion shaft PS as a pinion support portion (a differential gear support portion) which rotatably supports the pinions P; an input member I having a short cylindrical shape and supporting the pinion shaft PS so as to be capable of rotating together with the pinion shaft PS; a pair of left and right side gears (output gears) S in mesh with the pinions P from both the left and right sides, and connected respectively to the pair of left and right output shafts A; and a pair of left and right cover portions C, C′ covering outer sides of the respective side gears S, and rotating integrally with the input member I. A differential case DC is formed from the input member I and the cover portions C, C′.

Incidentally, the embodiment shows the differential device D which includes two pinions P, and whose pinion shaft PS as the pinion support portion is formed in a linear rod shape extending along one diameter line of the input member I with the two pinions P respectively supported by both end portions of the pinion shaft PS. Instead, the differential device D may include three or more pinions P. In this case, the pinion shaft PS is formed in a shape of crossing rods such that rods extend radially from a rotation axis L of the input member I in three or more directions corresponding to the three or more pinions P (for example, in a shape of a cross when the differential device D includes four pinions P), and tip end portions of the pinion shaft PS support the pinions P, respectively.

In addition, the pinions P may be fitted to the pinion shaft PS directly as shown in the illustrated example, or with bearing means (not illustrated), such as a bearing bush and the like, inserted between the pinion shaft PS and each pinion P. Furthermore, the pinion shaft PS may be formed in a shape of a shaft whose diameter is substantially equal throughout its whole length, or formed in a shape of a stepped shaft. Besides, in the embodiment, a pair of cutout surfaces 20 are formed in a predetermined area of an outer peripheral surface of each of both end portions of the pinion shaft PS, the predetermined area being wider than a fitting surface of the pinion shaft PS and each pinion P. Bottom surfaces of each pair of cutout surfaces 20 are formed as flat surface and are in parallel to each other. Furthermore, special installation of the cutout surfaces 20 enhances lubricating performance with respect to surroundings of each pinion P and slidable fitting portions of the pinion P and the pinion shaft PS. Incidentally, in addition to this embodiment, various modified embodiments are applicable to the form which the cutout surfaces 20 take on. The cutout surfaces 20 may be each formed, for example, as a spiral recessed groove or a straight groove extending along an axis of the shaft. Moreover, the cutout surfaces 20 may be omitted.

The differential case DC is rotatably supported to the transmission case 1 via left and right bearings 2. Moreover, through-holes 1a through which to insert the output shafts A are formed in the transmission case 1. Annular seal members 3 for sealing interstices between inner peripheries of the through-holes 1a and outer peripheries of the output shafts A are interposed between the inner peripheries and the outer peripheries. Furthermore, an oil pan (not illustrated) facing an inner space of the transmission case 1 and reserving a predetermined amount of lubricant oil is provided in a bottom portion of the transmission case 1. Mechanical interlocking sections existing inside and outside the differential case DC can be lubricated with the lubricant oil which is scattered around the differential device D inside the transmission case 1 by rotation of the differential case DC and the other rotary members.

An input tooth portion Ig as a final driven gear is provided in an outer peripheral portion of the input member I. This input tooth portion Ig is in mesh with a drive gear (not illustrated) which is rotationally driven by power of the engine. Incidentally, in the embodiment, the input tooth portion Ig is directly formed in an outer peripheral surface of the input member I over a full lateral width of the input member I (i.e., an overall axial width of the input member I). Instead, however, the input tooth portion Ig may be formed to have the width smaller than that of the input member I. Otherwise, the input tooth portion Ig may be formed separately from the input member I, and thereafter fixed to the outer peripheral portion of the input member I.

Meanwhile, in the embodiment, the pinions P and the side gears S are each formed as a bevel gear. In addition, each pinion P as a whole and each side gear S as a whole, including their tooth portions, are formed by plastic working such as forging and the like. For these reasons, their tooth portions with an arbitrary gear ratio can be precisely formed without restriction in machining work in the case where the tooth portions of the pinions P and the side gears S are formed by cutting work. Incidentally, other types of gears may be used instead of the bevel gear. For example, a face gear may be used for the side gears S, while a spur gear or a helical gear may be used for the pinions P.

In addition, the pair of side gears S each include: a shaft portion Sj to which an inner end portion of the corresponding one of the pair of output shafts A is connected by being spline-fitted and being formed in a cylindrical shape; a tooth portion Sg situated at a position separated outward from the shaft portion Sj in a radial direction of the input member I, being in mesh with the corresponding pinion P and being formed in an annular shape; and an intermediate wall portion Sw formed in a flat ring plate shape orthogonal to the axis L of the corresponding output shaft A and integrally connecting the shaft portion Sj and the tooth portion Sg.

The inner peripheral surface of the shaft portion Sj of each side gear S is provided with a spline 21 which is to be relatively unrotatably engaged with an outer peripheral spline 24 of the corresponding output shaft A. In addition, missing tooth portions 21n are formed by removing some of the teeth of the spline 21, and a plurality of lubricant oil passages 22 are formed between the missing tooth portions 21n and the outer peripheral spline 24 of the output shaft A, the plurality of lubricant oil passages 22 extending in an axial direction of the output shaft A and guiding lubricant oil from an outer end portion to an inner end portion of the shaft portion Sj in the axial direction. The lubricant oil which is scattered inside the transmission case 1 in response to rotation of the differential case DC can flow into the lubricant oil passages 22.

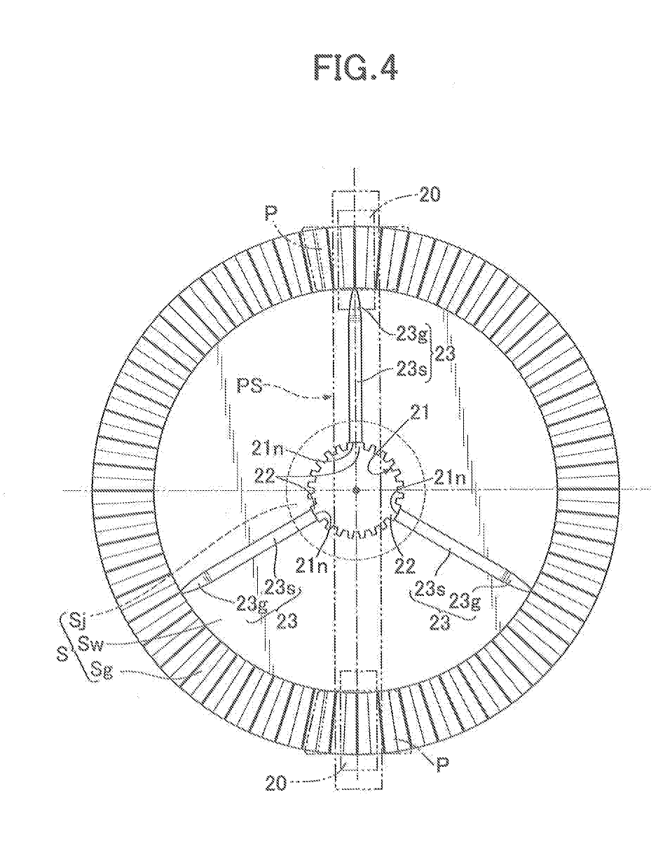

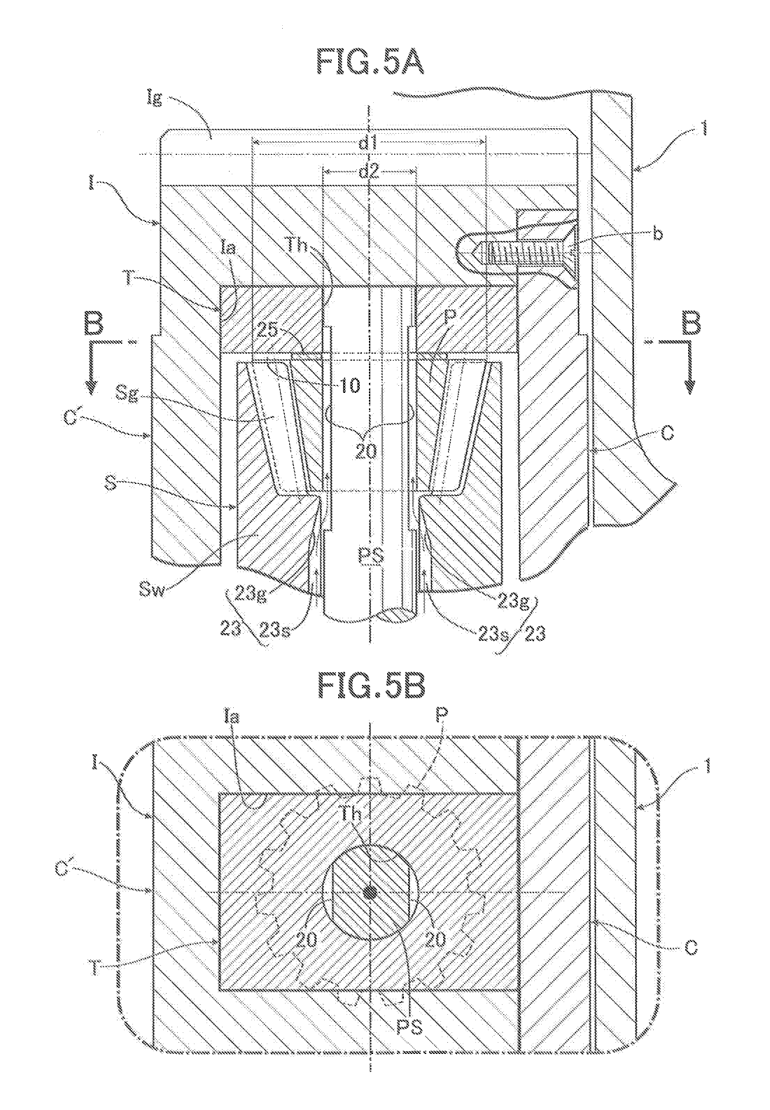

Referring to FIGS. 4, 5A and 5B together, a plurality of lubricant oil grooves 23 configured to supply the lubricant oil from inner ends of the lubricant oil passages 22 toward the tooth portions Sg of the side gear using centrifugal force are radially formed in an inner side surface of each side gear S which faces the other side gear S.

Each lubricant oil groove 23 includes: a straight groove portion 23s extending in a radial direction of the side gear S while having a bottom surface in parallel with an imaginary plane orthogonal to the axis L of the output shaft A; and a guide groove portion 23g continuous to an outer end of the straight groove portion 23s in the radial direction. Furthermore, a bottom surface of the guide groove portion 23g inclines relative to the bottom surface of the straight groove portion 23s in such a way that the guide groove portion 23g becomes gradually shallower in depth while extending from the bottom surface of the straight groove portion 23s toward the outside in the radial direction (i.e., toward the tooth portion Sg of the side gear S).

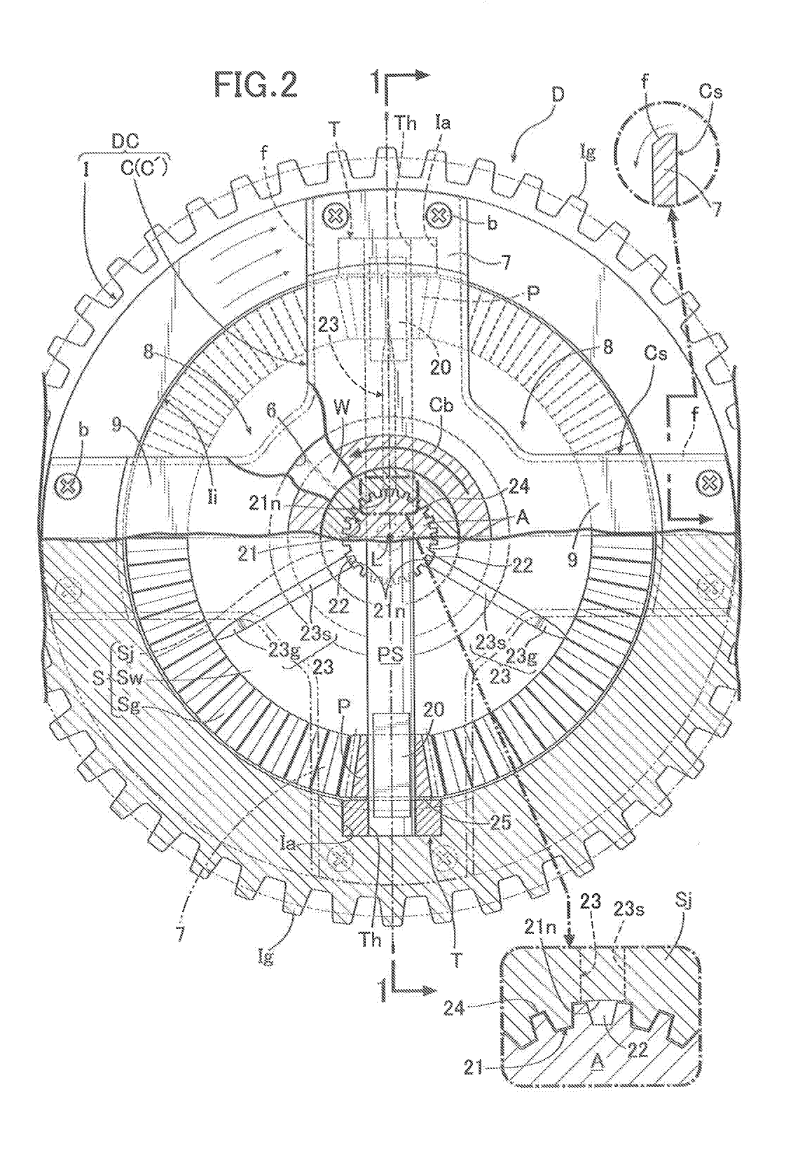

Moreover, as apparent from FIG. 2, as seen in a projection plane orthogonal to the axis L of the output shaft A, the guide groove portions 23g and parts of the cutout surfaces 20 formed in the outer peripheral surface of the pinion shaft PS are situated on a same circumference around the axis L. Thereby, while the differential device D is in operation, the lubricant oil can be efficiently supplied, by use of rotational force of the differential mechanism, to lubricant oil reservoirs (i.e., gap parts facing the cutout surfaces 20) between the fitting surfaces of each pinion P and the pinion shaft PS, which tend to seize up due to their high-speed rotation.

In addition, the intermediate wall portion Sw of the side gear S is formed with its width t1 in the radial direction larger than a maximum diameter d1 of the pinion P, and with its maximum thickness t2 in an axial direction of the output shaft A smaller than an effective diameter d2 of the pinion shaft PS (see FIG. 1). Thereby, as described later, a diameter of the side gear S can be made large enough to set the number Z1 of teeth of the side gear S sufficiently larger than the number Z2 of teeth of the pinions P, and the side gear S can be sufficiently thinned in the axial direction of the output shaft A. Incidentally, in the present specification, the “effective diameter d2” means an outer diameter d2 of the shaft (i.e., the pinion shaft PS, or a support shaft portion PS' which will be described later) as the pinion support portion which is formed separately from or integrally with the pinions P, supports the pinions and is attached to the input member I.

Moreover, the cover portion C, which is one of the pair of cover portions C, C′, is formed separately from the input member I, and is detachably connected to the input member I using bolts b. The connecting method may use various connecting means other than screw means. Examples of the various connecting means include welding means and swaging means. Meanwhile, the other cover portion C′ is formed integral with the input member I. Incidentally, like the one cover portion C, the other cover portion C′ may be formed separately from the input member I, and connected to the input member I using bolts b or other connecting means.

Besides, each of the cover portions C, C′ includes: a boss portion Cb which concentrically surrounds the shaft portion Sj of the side gear S, in which the shaft portion Sj is rotatably fitted and supported and being formed in a cylindrical shape; and a side wall portion Cs having an outer side surface which is a flat surface orthogonal to the rotation axis L of the input member I, the side wall portion Cs integrally connected to an inner end in an axial direction of the boss portion Cb and being formed in a plate shape.

Next, referring to FIGS. 5A, 5B together, descriptions will be provided for a configuration for attaching the pinion shaft PS, as the pinion support portion, to the input member I. Both end portions of the pinion shaft PS are connected to and supported by the input member I via attachment bodies T, respectively. A retaining hole Th is formed in each attachment body T, the retaining hole Th being capable of fitting and retaining an entire periphery of the corresponding end portion of the pinion shaft PS (see FIG. 1). Furthermore, attachment grooves Ia are provided a recess in an inner peripheral surface of the input member I. Each attachment groove Ia having an opening in a side surface of the input member I on the one cover portion C side, extending in the axial direction of the output shafts A and being formed in an angular U-shape as seen in a cross-section. Each attachment body T having a rectangular parallelepiped shape is inserted into the corresponding attachment groove Ia from the opening of the input member I. The attachment body T is fixed to the input member I by fastening the one cover portion C to the input member I using the bolts b with the attachment body T inserted in the attachment groove Ia of the input member I. In addition, a thrust washer 25 is installed between the attachment body T and a large diameter-side end surface of the pinion P, the thrust washer 25 allowing relative rotation therebetween and being formed in an annular shape.

The above-described structure for attaching the pinion shaft PS to the input member I enables the pinion shaft PS to be easily and firmly connected and fixed to the attachment grooves Ia in the input member I by use of the block-shaped attachment bodies T in which the entire peripheries of the end portions of the pinion shaft PS are fitted and retained. For this reason, the pinion shaft PS can be connected to and supported by the input member I with high strength, with no specialized through-hole for supporting the pinion shaft PS formed in the input member I, and without decreasing assembly workability. Furthermore, the embodiment achieves structure simplification since the cover portion C covering the outer side of the corresponding side gear S concurrently serves as the fixing means for retaining the attachment body T.

Thereby, when the both end portions of the pinion shaft PS are connected to and supported by the input member I via the attachment bodies T, clearances 10 in the radial direction of the input member I are formed between large diameter-side end surfaces of the pinions P rotatably supported by the pinion shaft PS and the inner peripheral surface of the input member I. This makes it easy for the lubricant oil to be reserved in the clearances 10, and is accordingly effective to prevent seizure in end portions of the pinions P facing the clearances 10, and their vicinities.

Meanwhile, the side wall portion Cs of the one cover portion C has a structure having oil retaining portions 7 covering parts of a back surface of the side gear S in first predetermined areas including areas which overlap the pinions P as seen in a side view from outside in the axial direction of the output shaft A (i.e., as seen in FIG. 2), and having lightening portions 8 exposing parts of the back surface of the side gear S to the outside of the differential case DC in second predetermined areas which do not overlap the pinions P as seen in the side view and connecting arm portions 9 being separated from the oil retaining portions 7 in the peripheral direction of the input member I, extending in the radial direction of the input member I and connecting between the boss portion Cb and the input member I. In other words, the side wall portion Cs basically having a disk shape in the cover portion C has a structural form in which: the plurality of lightening portions 8 each having a cutout shape are formed in the side wall portion Cs at intervals in the peripheral direction; and thereby, one oil retaining portion 7 and one connecting arm portion 9 are formed respectively on opposite sides of the lightening portion 8 in the peripheral direction.

The structural form of the side wall portion Cs of the cover portion C, particularly the oil retaining portions 7, makes it possible for the lubricant oil, which tends to move outward in the radial direction due to the centrifugal force produced by the rotation of the input member I, to stay in spaces covered by the oil retaining portions 7 and the input member I and to be easily retained around the pinions P and their vicinities. For this reason, it is possible to efficiently supply the lubricant oil to the pinions P and their vicinities. Accordingly, even under severe driving conditions and the like, such as the high-speed rotation of the pinions P, the lubricant oil can be efficiently supplied to the sliding portions of the pinions P and the meshing portions of the pinions P and the side gears S; and the seizure in the sliding portions and the meshing portions can be prevented effectively.

In addition, since the cover portion C includes the lightening portions 8, the lubricant oil can be distributed to the inside and outside of the differential case DC via the lightening portions 8. Thus, the lubricant oil is changed and cooled appropriately, thereby effectively preventing degradation of the lubricant oil. Furthermore, since a large amount of lubricant oil need not be confined inside the differential case DC, and since the cover portion C itself is reduced in weight by an amount of the forming of the lightening portions 8, reduction in the weight of the differential device D can be accordingly achieved.

It should be noted that although in the embodiment, the lightening portions 8 are each formed in the cutout shape which is opened on the outer peripheral end side of the side wall portion Cs, the lightening portions 8 may be instead each formed in a through-hole shape which is not opened on the outer peripheral end side thereof.

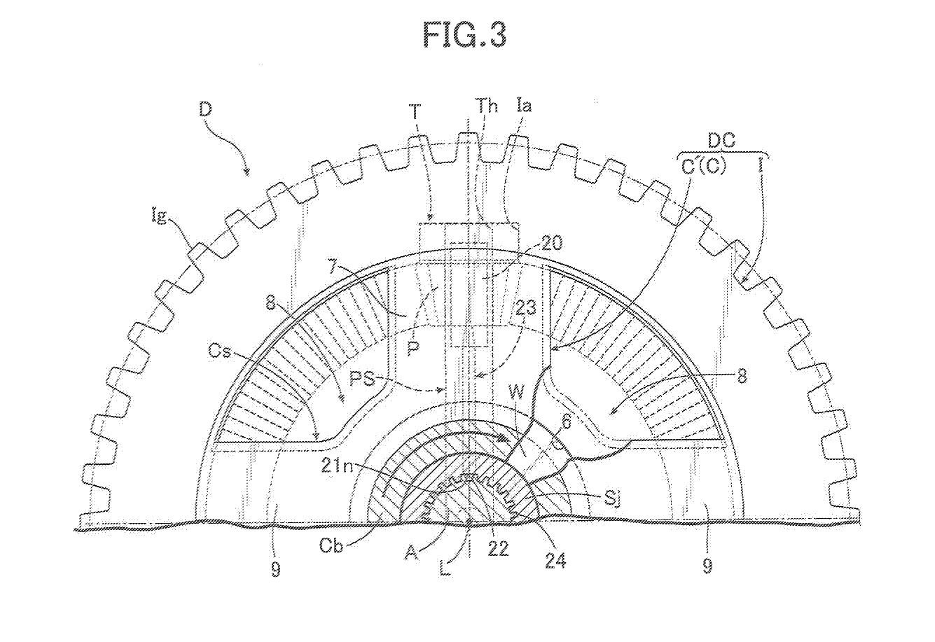

Furthermore, as apparent from FIG. 3, in this embodiment, the lightening portions 8 are formed in the side wall portion Cs of the other cover portion C′, like in the one cover portion C. In the side wall portion Cs of the other cover portion C′, however, the oil retaining portions 7 and the connecting arm portions 9 are formed integrally in the input member I. Incidentally, the side wall portion Cs of one of the cover portions C, C′ may be formed in a disk shape having no lightening portions (accordingly covering the entirety of the back surfaces of the intermediate wall portion Sw and the tooth portion Sg of the corresponding side gear S).

It should be noted that the structure for connecting the oil retaining portions 7 and the connecting arm portions 9 to the input member I has been described as the structure for connecting the cover portions C, C′ to the input member I. In other words, the oil retaining portions 7 and the connecting arm portions 9 may be formed integral with the input member I. Otherwise, in a case where the oil retaining portions 7 and the connecting arm portions 9 are formed separately from the input member I, the oil retaining portions 7 and the connecting arm portions 9 may be connected to the input member I using the screw means such as the bolts b and the like, or other various connecting means (for example, welding means, swaging means and the like).

Besides, the cover portions C, C′ of the embodiment have an oil guiding inclined surface f in a peripheral edge portion of each lightening portion 8, the oil guiding inclined surface f being capable of guiding flow of the lubricant oil into an inner side of the input member I during the rotation of the input member I. As seen in a cross-section crossing the oil retaining portions 7 and the connecting arm portions 9 in the peripheral direction of the input member I (see the partially cutaway sectional view in FIG. 2), the oil guiding inclined surface f is formed so as to be inclined to the respective center sides in the peripheral direction of the oil retaining portion 7 and the connecting arm portion 9, toward their respective inner side surfaces from their respective outer side surfaces. Thus, oil induction operation of the oil guiding inclined surface f makes it possible for the lubricant oil to smoothly flow from the outer side to the inner side of each of the cover portions C, C′ in accordance with rotation of the differential case DC, and accordingly enhances the effect of lubricating the pinions P and the like.

Moreover, various modified embodiments can be created for the form of the lightening portions 8 (accordingly, the oil retaining portions 7 and the connecting arm portions 9) of the cover portions C, C′, and the form of the lightening portions 8 is not limited to the embodiment shown in FIGS. 2 and 3.

Next, descriptions will be provided for an operation of the embodiment. In the differential device D of the embodiment, in a case where the input member I receives rotational force from a power source, when the pinion P revolves around the axis L of the input member I together with the input member I, without rotating around the pinion shaft PS, the left and right side gears S are rotationally driven at the same speed, and their driving forces are evenly transmitted to the left and right output shafts A. Meanwhile, when a difference in rotational speed occurs between the left and right output shafts A due to turn traveling or the like of the automobile, the pinion P revolves around the axis L of the input member I while rotating around the pinion shaft PS. Thereby, the rotational driving force is transmitted from the pinion P to the left and right side gears S while allowing differential rotations. The above is the same as the operation of the conventional differential device.

Meanwhile, while the differential device D is in operation, the lubricant oil is forcefully scattered in various places inside the transmission case 1 in accordance with the rotation of the differential case DC. Part of the scattered lubricant oil flows into the lubricant oil passages 22 formed between the tooth lacking portions 21n in the inner peripheral splines 21 of the shaft portions Sj of the side gears S and the outer peripheral splines 24 of the output shafts A, and thereafter reaches the central portions of the inner side surfaces of the side gears S. After that, the part of the scattered lubricant oil flows in the lubricant oil grooves 23 in the inner side surfaces of the side gears S toward the outside in the radial direction due to the centrifugal force, and reaches the tooth portions Sg of the side gears S. Thereby, even in a case where the tooth portions Sg of the side gear place farther from the output shafts A due to increase in the diameter of the side gear S, or even under severe driving conditions such as the high-speed rotation of the pinions P, the lubricant oil can be efficiently supplied from the output shaft P sides to the meshing portions of the pinions P and the side gears S and the sliding portions of the pinions P. Accordingly, the seizure in the meshing portions and the sliding portions can be prevented effectively.

In this case, each lubricant oil groove 23 includes: the straight groove portion 23s extending in the radial direction of the side gear S while having the bottom surface in parallel with the imaginary plane orthogonal to the axis L of the output shaft A and the guide groove portion 23g continuous to the outer end of the straight groove portion 23s, the bottom surface of the guide groove portion 23g inclining relative to the bottom surface of the straight groove portion 23s in such a way that the depth of the guide groove portion 23g becomes gradually shallower from the bottom surface of the straight groove portion 23s toward the outside in the radial direction (i.e., toward the tooth portion Sg of the side gear S). This configuration allows the lubricant oil to flow smoothly from the guide groove portion 23g toward the tooth portion Sg of the side gear, the lubricant oil flowing straight through the straight groove portion 23s of the lubricant oil groove 23 outwards in the radial direction. Accordingly, the effect of lubricating the meshing portions of the pinions P and the side gears S can be enhanced more.

Moreover, in the embodiment, as described above, the lightening portions 8 are formed in each of the left and right cover portions C, C′ covering the back surfaces of the left and right side gears S, and the lubricant oil scattered around the differential device D inside the transmission case 1 efficiently flows into the differential case DC via the lightening portions 8 as well. This makes it possible to more enhance the effect of lubricating the meshing portions of the pinions P and the side gears S and the sliding portions of the pinions P.

In addition, in the differential device D of the embodiment, each side gear S includes: the shaft portion Sj connected to the output shaft A; and the intermediate wall portion Sw formed in a flat ring plate shape orthogonal to the axis L of the output shaft A and integrally connecting between the shaft portion Sj and the tooth portion Sg of the side gear, the tooth portion Sg being separated outward from the shaft portion Sj in the radial direction of the input member I. Furthermore, in each side gear S, the intermediate wall portion Sw is formed in the way that its width t1 in the radial direction is longer than a maximum diameter d1 of each pinion P. For these reasons, relative to the pinions P, the diameter of the side gear S can be made large enough to set the number Z1 of teeth of the side gear S sufficiently larger than the number Z2 of teeth of the pinions P. This makes it possible to reduce load burden to the pinion shaft PS while the torque is being transmitted from the pinions P to the side gears S, and thus to decrease the effective diameter d2 of the pinion shaft PS, accordingly the width of the pinions P in the axial direction of the output shafts A.

In addition, since the load burden to the pinion shaft P is reduced as describe above, since reaction force applied to each side gear S decreases, and since the back surface of the intermediate wall portion Sw or the tooth portion Sg of the side gear S is supported by the corresponding cover side wall portion Cs, it is easy to secure the rigidity strength needed for the side gear S even though the intermediate wall portion Sw of the side gear S is thinned. That is to say, it is possible to sufficiently thin the intermediate wall portion Sw of the side gear while securing the support rigidity with respect to the side gear S. Moreover, in the embodiment, since the maximum thickness t2 of the intermediate wall portion Sw of the side gear is formed much smaller than the effective diameter d2 of the pinion shaft PS whose diameter can be made smaller as described above, the further thinning of the intermediate wall portion Sw of the side gear can be achieved. Besides, since the cover side wall portion Cs is formed in a plate shape such that the outer side surface thereof is the flat surface orthogonal to the axis L of the corresponding output shaft A, the thinning of the cover side wall portion Cs itself can be achieved.

As a result of these, the width of the differential device D as a whole can be sufficiently decreased in the axial direction of the output shafts A while securing as approximately the same strength (for example, static torsion load strength) and as approximately the same amount of maximum torque transmission compared with the conventional differential device. This makes it possible to easily incorporate the differential device D, with great freedom and without trouble, even when a transmission system imposes many restrictions on the layout of the vicinity of the differential device D, and is extremely advantageous in reducing the size of the transmission system.

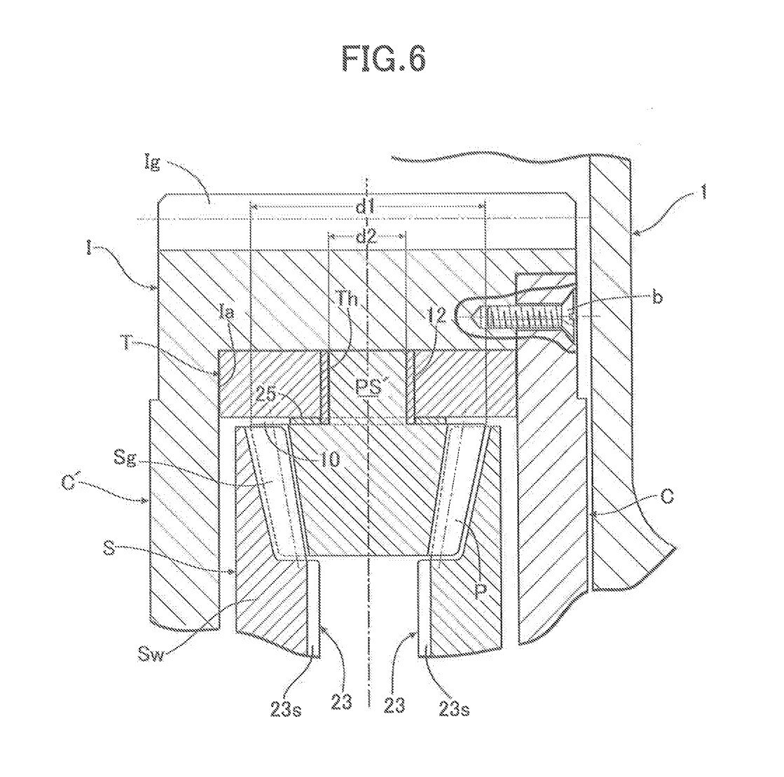

Meanwhile, although the above-described embodiment where the long pinion shaft PS is used as the pinion support portion has been shown, the pinion support portion may be formed from a support shaft portion PS' coaxially and integrally connected to a large diameter-side end surface of the pinion P as shown in FIG. 6. According to this configuration, because the through-hole into which the pinion shaft PS is fitted need not be provided to the pinion P, the diameter of the pinion P can be accordingly decreased (the width thereof can be decreased in the axial direction), and the differential device D can be flattened in the axial direction of the output shafts A. In other words, when the pinion shaft PS is penetrated through the pinion P, it is necessary to form in the pinion P the through-hole with a size corresponding to the pinion shaft diameter. However, when the support shaft portion PS' is integrated with the end surface of the pinion P, it is possible to decrease the diameter of the pinion P (to decrease the width thereof in the axial direction) without depending on a diameter of the support shaft portion PS′.

Furthermore, in this modified embodiment, each lubricant oil groove 23 formed in the inner side surface of each side gear S is formed from only the straight groove portion 23s having the bottom surface in parallel with the imaginary plane orthogonal to the axis L of the output shafts A, and includes no groove portion having an inclined bottom surface, which corresponds to the guide groove portion 23g of the foregoing embodiment.

Moreover, in this modified embodiment, a bearing bush 12 as a bearing for allowing relative rotations between the support shaft portion PS' and the attachment body T is inserted between an outer peripheral surface of the support shaft portion PS' and an inner peripheral surface of the retaining hole Th of the corresponding attachment body T into which the support shaft portion PS' is inserted. Incidentally, the bearing may be formed from a needle bearing or the like. In addition, the bearing may be omitted so that the support shaft portion PS' is directly fitted into the retaining hole Th of the attachment body T.

Meanwhile, in the conventional differential devices exemplified in Japanese Patent No. 4803871 and Japanese Patent Application KOKAI Publication No. 2002-364728 which are described above, the number Z1 of teeth of the side gear (output gear) and the number Z2 of teeth of the pinion (differential gear) are generally set at 14 and 10, 16 and 10, or 13 and 9, respectively, as shown in Japanese Patent Application KOKAI Publication No. 2002-364728, for example. In these cases, the number-of-teeth ratios Z1/Z2 of the output gears to the differential gears are 1.4, 1.6 and 1.44, respectively. In addition, other publicly-known examples of the combination of the number Z1 of teeth and the number Z2 of teeth for conventional differential devices include 15 and 10, 17 and 10, 18 and 10, 19 and 10, and 20 and 10. In these cases, the number-of-teeth ratios Z1/Z2 are at 1.5, 1.7, 1.8, 1.9 and 2.0, respectively.

On the other hand, nowadays, there is an increase in the number of transmission systems which are under layout restrictions around their respective differential devices. Accordingly, the market demands that differential devices be sufficiently reduced in width (i.e., thinned) in the axial direction of their output shafts while securing the gear strength for the differential devices. However, the structural forms of the conventional existing differential devices are wide in the axial direction of the output shafts, as apparent from the gear combinations leading to the above-mentioned number-of-teeth ratios. This makes it difficult to satisfy the market demand.

With this taken into consideration, an attempt to find a concrete configuration example of the differential device D which can be sufficiently reduced in width (i.e., thinned) in the axial direction of the output shafts while securing the gear strength for the differential device has been made as follows, from a viewpoint different from that of the foregoing embodiment. Incidentally, the structures of the components of the differential device D of this configuration example are the same as the structures of the components of the differential device D of the foregoing embodiments which has been described using FIGS. 1 to 6. For this reason, the components of the configuration example will be denoted with the same reference signs as those of the embodiments, and descriptions for the structures will be omitted.

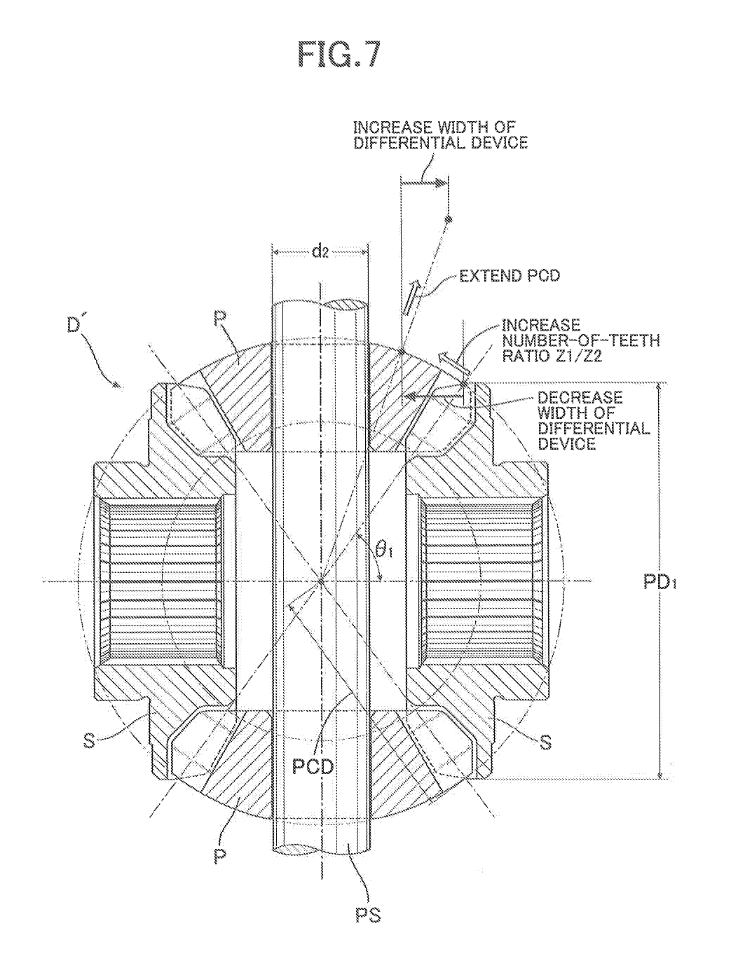

To begin with, let us explain a basic concept for sufficiently reducing the width of (i.e., thinning) the differential device D in the axial direction of the output shafts A referring to FIG. 7 together. The concept is as follows.

Approach [1] To make the number-of-teeth ratio Z1/Z2 of the side gear S, that is, the output gear to the pinion P, that is, the differential gear larger than the number-of-teeth ratio used for the conventional existing differential device. (This leads to a decrease in the module (accordingly the tooth thickness) of the gear and a resultant decrease in the gear strength, while leading to an increase in the pitch circle diameter of the side gear S, a resultant decrease in transmission load in the meshing portion of the gear, and a resultant increase in the gear strength. However, the gear strength as a whole decreases, as discussed below.)
Approach [2] To make the pitch cone distance PCD of the pinion P larger than the pitch cone distance in the conventional existing differential device. (This leads to an increase in the module of the gear and a resultant increase in the gear strength, while leading to an increase in the pitch circle diameter of the side gear S, a resultant decrease in the transmission load in the meshing portion of the gear, and a resultant increase in the gear strength. Thus, the gear strength as a whole increases greatly, as discussed below.)

For these reasons, when the number-of-teeth ratio Z1/Z2 and the pitch cone distance PCD are set such that the amount of decrease in the gear strength based on Approach [1] is equal to the amount of increase in the gear strength based on Approach [2] or such that the amount of increase in the gear strength based on Approach [2] is greater than the amount of decrease in the gear strength based on Approach [1], the gear strength as a whole can be made equal to or greater than that of the conventional existing differential device.

Next, let us concretely examine how the gear strength changes based on Approaches [1] and [2] using mathematical expressions. Incidentally, the examination will be described in the following embodiment. First of all, a “reference differential device” is defined as a differential device D′ in which the number Z1 of teeth of the side gear S is set at 14 while the number Z2 of teeth of the pinion P is set at 10. In addition, for each variable, a “change rate” is defined as a rate of change in the variable in comparison with the corresponding base number (i.e., 100%) of the reference differential device D′.

### Approach [1]

When M, PD₁, θ₁, PCD, F, and T respectively denote the module, pitch circle diameter, pitch angle, pitch cone distance, transmission load in the gear meshing portion, and transmission torque in the gear meshing portion, of the side gear S, general formulae concerning the bevel gear provide

M=PD₁/Z1,

PD₁=2PCD·sin θ₁, and

θ₁=tan⁻¹(Z1/Z2).

From these expressions, the module of the gear is expressed with

M=2PCD·sin {tan⁻¹(Z1/Z2)}/Z1 (1)

Meanwhile, the module of the reference differential device D′ is expressed with

2PCD·sin {tan⁻¹(7/5)}/14.

Dividing the term on the right side of Expression (1) by 2PCD·sin {tan⁻¹(7/5)}/14 yields a module change rate with respect to the reference differential device D′, which is expressed with Expression (2) given below.

$$Module Change Rate = \frac{14 \cdot sin ( {tan}^{- 1} \frac{z 1}{z 2} )}{z 1 \cdot sin ( {tan}^{- 1} \frac{7}{5} )} \qquad ( 2 )$$

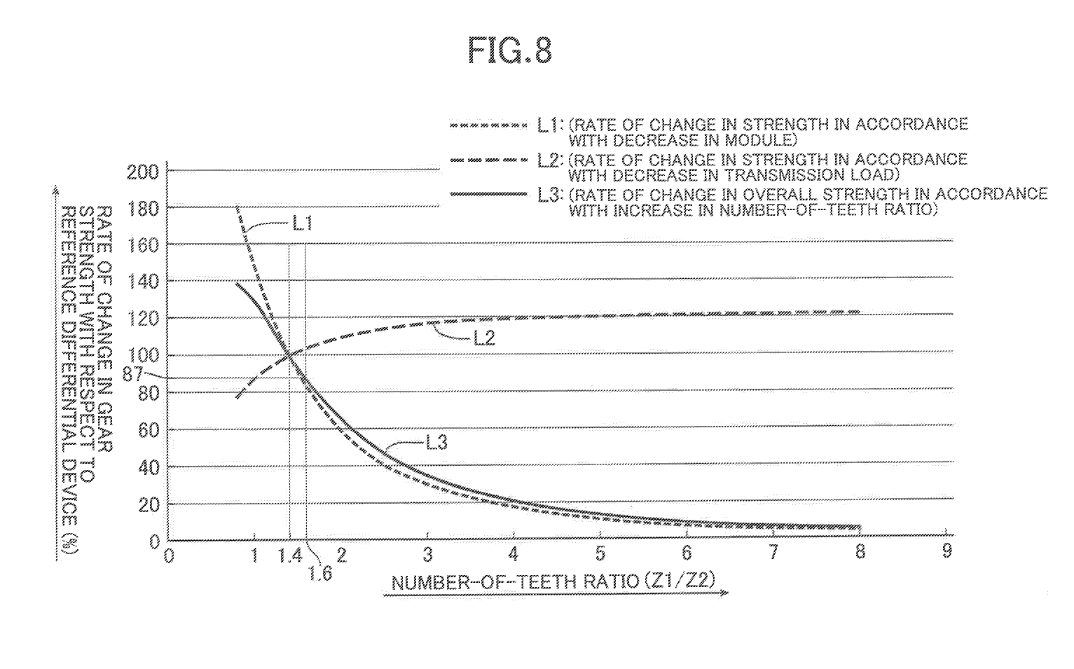

In addition, the section modulus of the tooth portion corresponding to the gear strength (i.e., the bending strength of the tooth portion) is in proportion to the square of the tooth thickness, while the tooth thickness has a substantially linear relationship with the module M. For these reasons, the square of the module change rate corresponds to a rate of change in the section modulus of the tooth portion, accordingly a gear strength change rate. In other words, based on Expression (2) given above, the gear strength change rate is expressed with Expression (3) given below. Expression (3) is represented by a line L1 in FIG. 8 when the number Z2 of teeth of the pinion P is 10. From the line L1, it is learned that as the number-of-teeth ratio Z1/Z2 becomes larger, the module becomes smaller and the gear strength accordingly becomes lower.

$$\begin{matrix}Gear Strength Change Rate = {( Module Change Rate )}^{2} \\ = \frac{196 \cdot {sin}^{2} ( {tan}^{- 1} \frac{z 1}{z 2} )}{z {1}^{2} \cdot {sin}^{2} ( {tan}^{- 1} \frac{7}{5} )}\end{matrix} \qquad ( 3 )$$

Meanwhile, based on the general formulae concerning the bevel gear, a torque transmission distance of the side gear S is expressed with Expression (4) given below.

PD₁/2=PCD·sin {tan⁻¹(Z1/Z2)} (4)

From the torque transmission distance PD₁/2, the transmission load F is given as

F=2T/PD₁.

For this reason, when the torque T of the side gear S of the reference differential device D′ is constant, the transmission load F is in inverse proportion to the pitch circle diameter PD₁. In addition, the rate of change in the transmission load F is in inverse proportion to the gear strength change rate. For this reason, the gear strength change rate is equal to the rate of change in the pitch circle diameter PD₁.

As a result, using Expression (4), the rate of change in the pitch circle diameter PD₁ is expressed with Expression (5) given below.

$$\begin{matrix}Gear Strength Change Rate = P {D}_{1} Change Rate \\ = \frac{sin ( {tan}^{- 1} \frac{z 1}{z 2} )}{sin ( {tan}^{- 1} \frac{7}{5} )}\end{matrix} \qquad ( 5 )$$

Expression (5) is represented by a line L2 in FIG. 8 when the number Z2 of teeth of the pinion P is 10. From the line L2, it is learned that as the number-of-teeth ratio Z1/Z2 becomes larger, the transmission load becomes smaller, and the gear strength accordingly becomes stronger.

Eventually, the gear strength change rate in accordance with the increase in the number-of-teeth ratio Z1/Z2 is expressed with Expression (6) given below by multiplying a rate of decrease change in the gear strength in accordance with the decrease in the module M (the term on the right side of Expression (3) shown above) and a rate of increase change in the gear strength in accordance with the decrease in the transmission load (the term on the right side of Expression (5) shown above).

$$Gear Strength Change Rate In Accordance with Number \text{-} of \text{-} Teeth Ratio = \frac{196 \cdot {sin}^{3} ( {tan}^{- 1} \frac{z 1}{z 2} )}{z {1}^{2} \cdot {sin}^{3} ( {tan}^{- 1} \frac{7}{5} )} \qquad ( 6 )$$

Expression (6) is represented by a line L3 in FIG. 8 when the number Z2 of teeth of the pinion P is 10. From the line L3, it is learned that as the number-of-teeth ratio Z1/Z2 becomes larger, the gear strength as a whole becomes lower.

### Approach [2]

In a case of increasing the pitch cone distance PCD of the pinion P more than the pitch cone distance in the reference differential device D′, when PCD1, PCD2 respectively denote the pitch cone distance PCD before the change and the pitch cone distance PCD after the change, the module change rate in accordance with the change in the pitch cone distance PCD is expressed with

PCD2/PCD1

if the number of teeth is constant, based on the above-mentioned general formulae concerning the bevel gear.

Meanwhile, as being clear from the above-discussed process for deriving Expression (3), the gear strength change rate of the side gear S corresponds to the square of the module change rate. For this reason,

Gear Strength Change Rage in Accordance with Increase in Module=(PCD2/PCD1)² (7)

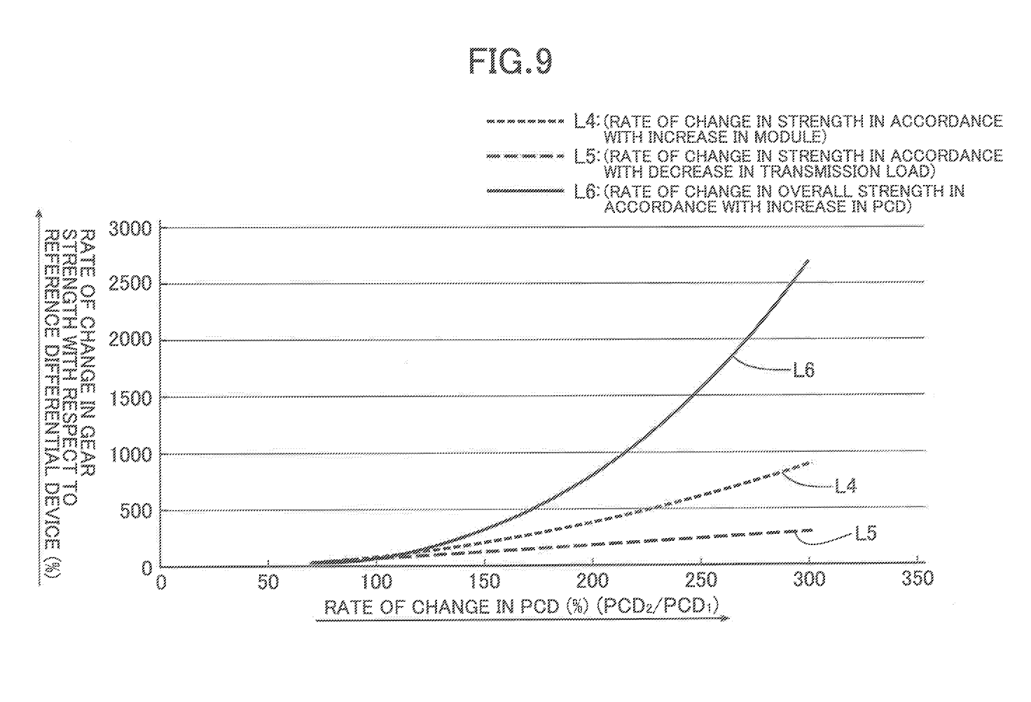

is obtained. Expression (7) is represented by a line L4 in FIG. 9. From the line L4, it is learned that as the pitch cone distance PCD becomes larger, the module becomes larger, and the gear strength accordingly becomes stronger.

In addition, when the pitch cone distance PCD is made larger than the pitch cone distance PCD1 in the reference differential device D′, the transmission load F decreases. Thereby, the gear strength change rate becomes equal to the rate of change in the pitch circle diameter PD₁, as described above. In addition, the pitch circle diameter PD₁ of the side gear S is in proportion to the pitch cone distance PCD. For these reasons,

Gear Strength Change Rate in Accordance with Decrease in Transmission Load=PCD2/PCD1 (8)

is obtained.

Expression (8) is represented by a line L5 in FIG. 9. From the line L5, it is learned that as the pitch cone distance PCD becomes larger, the transmission load becomes lower, and the gear strength accordingly becomes stronger.

In addition, the gear strength change rate in accordance with the increase in the pitch cone distance PCD is expressed with Expression (9) given below by multiplying the rate of increase change in the gear strength in accordance with the increase in the module M (the term on the right side of Expression (7) shown above) and the rate of increase change in the gear strength in accordance with the decrease in the transmission load in response to the increase in the pitch circle diameter PD (the term on the right side of Expression (8) shown above).

Gear Strength Change Rate in Accordance with Increase in Pitch Cone Distance=(PCD2/PCD1)³ (9)

Expression (9) is represented by a line L6 in FIG. 9. From the line L6, it is learned that as the pitch cone distance PCD becomes larger, the gear strength is increased greatly.

With these taken into consideration, the combination of the number-of-teeth ratio Z1/Z2 and the pitch cone distance PCD is determined such that: the decrease in the gear strength based on Approach [1] given above (the increase in the number-of-teeth ratio) is sufficiently compensated for by the increase in the gear strength based on Approach [2] given above (the increase in the pitch cone distance) so as to make the overall gear strength of the differential device equal to or greater than the gear strength of the conventional existing differential device.

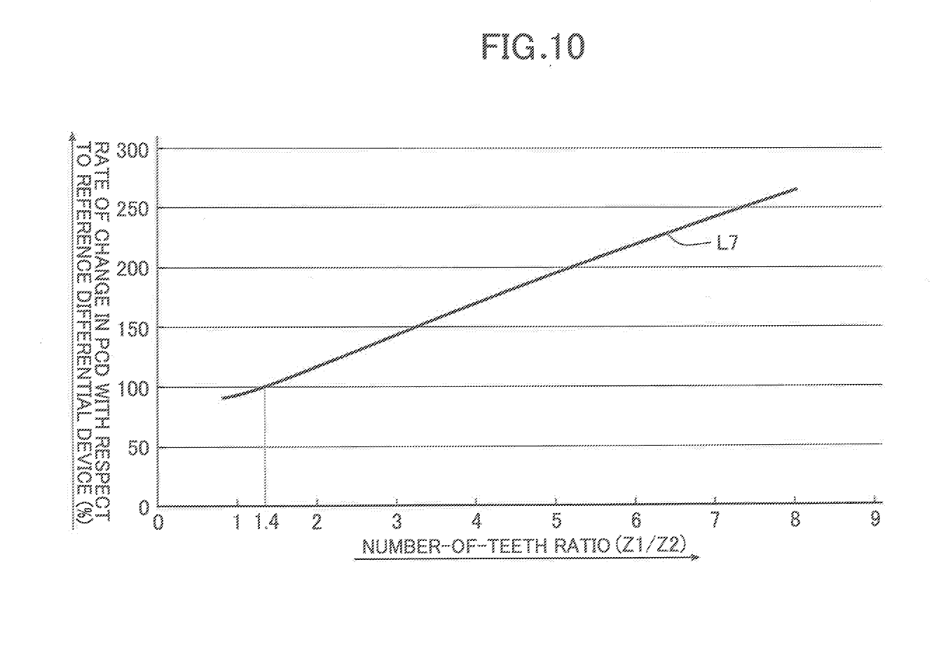

For example, 100% of the gear strength of the side gear S of the reference differential device D′ can be kept by setting the gear strength change rate in accordance with the increase in the number-of-teeth ratio (i.e., the term on the right side of Expression (6) given above) obtained based on Approach

[1] given above and the gear strength change rate in accordance with the increase in the pitch cone distance (i.e., the term on the right side of Expression (9) given above) obtained based on Approach [2] given above, such that the multiplication of these gear strength change rates becomes equal to 100%. Thereby, the relationship between the number-of-teeth ratio Z1/Z2 and the rate of change in the pitch cone distance PCD for keeping 100% of the gear strength of the reference differential device D′ can be obtained from Expression (10) given below. Expression (10) is represented by a line L7 in FIG. 10 when the number Z2 of teeth of the pinion P is 10.

$$\begin{matrix}P C D2 / P C D 1 = {( \begin{matrix}100 \% / Gear Strength Change Rate \\ \begin{matrix} in Accordance with Number \text{-} of \text{-} \\ Teeth Ratio\end{matrix}\end{matrix} )}^{\frac{1}{3}} \\ = {\{ \frac{1}{\frac{196 \cdot {sin}^{3} ( {tan}^{- 1} \frac{z 1}{z 2} )}{z {1}^{2} \cdot {sin}^{3} ( {tan}^{- 1} \frac{7}{5} )}} \}}^{\frac{1}{3}} \\ = {( \frac{z 1}{14} )}^{\frac{2}{3}} \cdot \frac{sin ( {tan}^{- 1} \frac{7}{5} )}{sin ( {tan}^{- 1} \frac{z 1}{z 2} )}\end{matrix} \qquad ( 10 )$$

Like this, Expression (10) represents the relationship between the number-of-teeth ratio Z1/Z2 and the rate of change in the pitch cone distance PCD for keeping 100% of the gear strength of the reference differential device D′ when the number-of-teeth ratio Z1/Z2 is equal to 14/10 (see FIG. 10). The rate of change in the pitch cone distance PCD represented by the vertical axis in FIG. 10 can be converted into a ratio of d2/PCD where d2 denotes a shaft diameter of the pinion shaft PS (i.e., the pinion support portion) supporting the pinion P.

TABLE 1

| PCD | SHAFT DIAMETER (d2) | d2/PCD |
|---|---|---|
| 31 | 13 | 42% |
| 35 | 15 | 43% |
| 38 | 17 | 45% |
| 39 | 17 | 44% |
| 41 | 18 | 44% |
| 45 | 18 | 40% |

To put it concretely, in the conventional existing differential device, the increase change in the pitch cone distance PCD correlates with the increase change in the shaft diameter d2 as shown in Table 1, and can be represented by a decrease in the ratio of d2/PCD when d2 is constant. In addition, in the conventional existing differential device, d2/PCD falls within a range of 40% to 45% as shown in Table 1 given above when the conventional existing differential device is the reference differential device D′, and the gear strength increases as the pitch cone distance PCD increases. Judging from these, the gear strength of the differential device can be made equal to or greater than the gear strength of the conventional existing differential device by determining the shaft diameter d2 of the pinion shaft PS and the pitch cone distance PCD such that at least d2/PCD is equal to or less than 45%, when the differential device is the reference differential device D′. In other words, when the differential device is the reference differential device D′, it suffices if d2/PCD<0.45 is satisfied. In this case, when PCD2 denotes the pitch cone distance PCD which is changed to become larger or less than the pitch cone distance PCD1 of the reference differential device D′, it suffices if

d2/PCD2<0.45/(PCD2/PCD1) (11)

is satisfied. Furthermore, the application of Expression (11) to Expression (10) given above can convert the relationship between d2/PCD and the number-of-teeth ratio Z1/Z2 into Expression (12) given below.

$$\begin{matrix}d 2 / P C D ≦ 0.45 / ( P C D 2 / P C D 1 ) \\ = 0.45 / \{ {( \frac{z 1}{14} )}^{\frac{2}{3}} \cdot \frac{sin ( {tan}^{- 1} \frac{7}{5} )}{sin ( {tan}^{- 1} \frac{z 1}{z 2} )} \} \\ = 0.45 \cdot {( \frac{14}{z 1} )}^{\frac{2}{3}} \cdot \frac{sin ( {tan}^{- 1} \frac{z 1}{z 2} )}{sin ( {tan}^{- 1} \frac{7}{5} )} & ( 12 )\end{matrix} \qquad$$

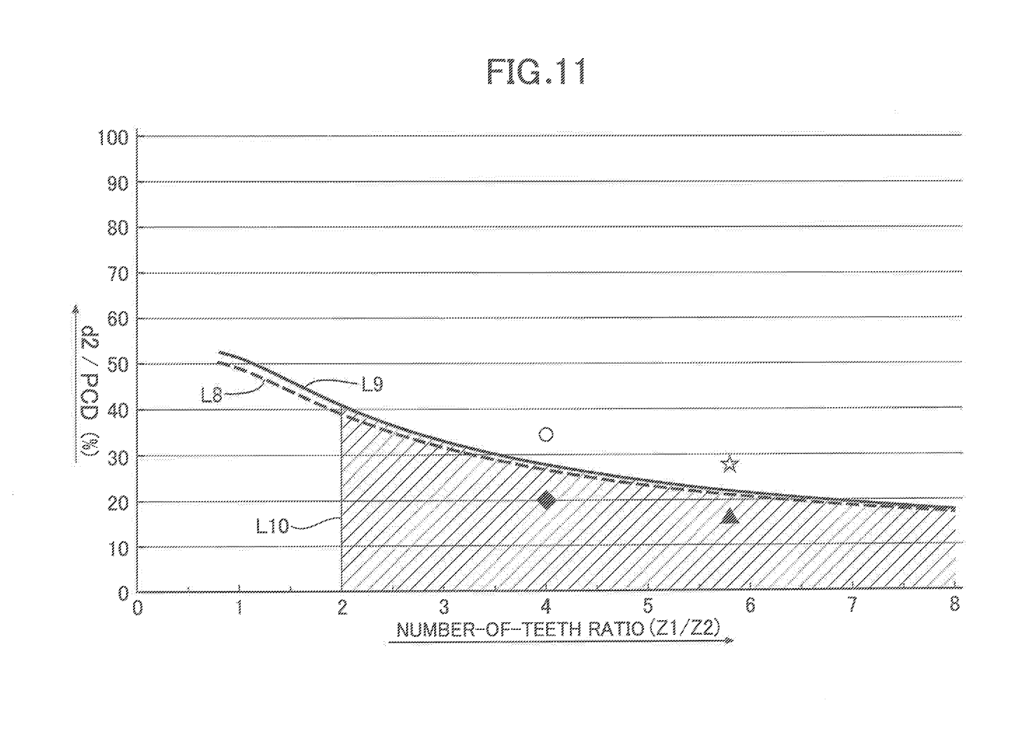

When the Expression (12) is equal, Expression (12) can be represented by a line L8 in FIG. 11 if the number Z2 of teeth of the pinion P is 10. When the Expression (12) is equal, the relationship between d2/PCD and the number-of-teeth ratio Z1/Z2 keeps 100% of the gear strength of the reference differential device D′.

Meanwhile, in conventional existing differential devices, usually, not only the number-of-teeth ratio Z1/Z2 equal to 1.4 used above to explain the reference differential device D′ but also the number-of-teeth ratio Z1/Z2 equal to 1.6 or 1.44 is adopted. This needs to be taken into consideration. Based on the assumption that the reference differential device D′ (Z1/Z2=1.4) guarantee the necessary and sufficient gear strength, that is, 100% of gear strength, it is learned, as being clear from FIG. 8, that the gear strength of conventional existing differential devices in which the number-of-teeth ratio Z1/Z2 is 16/10 is as low as 87% of the gear strength of the reference differential device D′. The general practice, however, is that the gear strength low at that level is accepted as practical strength and actually used for conventional existing differential devices. Judging from this, one may consider that gear strength which needs to be sufficiently secured for and is acceptable for the differential device which is thinned in the axial direction is at least equal to, or greater than, 87% of the gear strength of the reference differential device D′.

From the above viewpoint, first, a relationship for keeping 87% of the gear strength of the reference differential device D′ is obtained between the number-of-teeth ratio Z1/Z2 and the rate of change in the pitch cone distance PCD. The relationship can be expressed with Expression (10′) given below by performing a calculation by emulating the process of deriving Expression (10) given above (i.e., a calculation such that the multiplication of the gear strength change rate in accordance with the increase in the number-of-teeth ratio (i.e., the term on the right side of Expression (6) given above) and the gear strength change rate in accordance with the increase in the pitch cone distance (i.e., the term on the right side of Expression (9) given above) becomes equal to 87%).

$$\begin{matrix}P C D2 / P C D 1 = {( \begin{matrix}87 \% / Gear Strength Change Rate \\ \begin{matrix} in Accordance with Number \text{-} of \text{-} \\ Teeth Ratio\end{matrix}\end{matrix} )}^{\frac{1}{3}} \\ = {\{ \frac{0.87}{\frac{196 \cdot {sin}^{3} ( {tan}^{- 1} \frac{z 1}{z 2} )}{z {1}^{2} \cdot {sin}^{3} ( {tan}^{- 1} \frac{7}{5} )}} \}}^{\frac{1}{3}} \\ = {0.87}^{\frac{1}{3}} \cdot {( \frac{z 1}{14} )}^{\frac{2}{3}} \cdot \frac{sin ( {tan}^{- 1} \frac{7}{5} )}{sin ( {tan}^{- 1} \frac{z 1}{z 2} )}\end{matrix} \qquad ( {10}^{′} )$$

Thereafter, when Expression (11) given above is applied to Expression (10′) given above, the relationship between d2/PCD and the number-of-teeth ratio Z1/Z2 for keeping 87% or more of the gear strength of the reference differential device D′ can be converted into Expression (13) given below. However, the calculation is performed using the following rules that: the number of significant figures is three for all the factors, except for factors expressed with variables; digits below the third significant figure are rounded down; and although the result of the calculation cannot avoid approximation by an calculation error, the mathematical expression uses the equals sign because the error is negligible.

$$d 2 / P C D ≦ 0.45 / \{ {0.87}^{\frac{1}{3}} \cdot {( \frac{z 1}{14} )}^{\frac{2}{3}} \cdot \frac{sin ( {tan}^{- 1} \frac{7}{5} )}{sin ( {tan}^{- 1} \frac{z 1}{z 2} )} \} \\ = 3.3 \; 6 \cdot {( \frac{1}{z 1} )}^{\frac{2}{3}} \cdot sin ( {tan}^{- 1} \frac{z 1}{z 2} ) \qquad ( 13 )$$

When the Expression (13) is equal, Expression (13) can be represented by FIG. 11 (more specifically, by a line L9 in FIG. 11) if the number Z2 of teeth of the pinion P is 10. In this case, an area corresponding to Expression (13) is an area on and under the line L9 in FIG. 11. In addition, a specific area (a hatched area in FIG. 11) satisfying Expression (13) and located on the right side of a line L10 in FIG. 11 where the number-of-teeth ratio Z1/Z2>2.0 is satisfied is an area for setting Z1/Z2 and d2/PCD which enable at least 87% or more of the gear strength of the reference differential device D′ to be secured particularly for the differential device thinned in the axial direction where the number Z2 of teeth of the pinion P is 10 and the number-of-teeth ratio Z1/Z2 is greater than 2.0. For reference, a black diamond in FIG. 11 represents an example where the number-of-teeth ratio Z1/Z2 and d2/PCD are set at 40/10 and 20.00%, respectively, and a black triangle in FIG. 11 represents an example where the number-of-teeth ratio Z1/Z2 and d2/PCD are set at 58/10 and 16.67%, respectively. These examples fall within the specific area. A result of a simulation for strength analysis on these examples has confirmed that the gear strength equal to or greater than those of the conventional differential devices (more specifically, the gear strength equal to or greater than 87% of the gear strength of the reference differential device D′) were obtained.

Thus, the thinned differential device falling within the specific area is configured as the differential device which, as a whole, is sufficiently reduced in width in the axial direction of the output shafts while securing the gear strength (for example, static torsion load strength) and the maximum amount of torque transmission at approximately the same levels as the conventional existing differential devices which are not thinned in the axial direction thereof. Accordingly, it is possible to achieve effects of: being capable of easily incorporating the differential device in a transmission system, which is under many layout restrictions around the differential device, with great freedom and no specific difficulties; being extremely advantageous in reducing the size of the transmission system; and the like.

Moreover, when the thinned differential device in the specific area has, for example, the structure of the above-mentioned embodiment (more specifically, the structures shown in FIGS. 1 to 6), the thinned differential device in the specific area can obtain an effect derived from the structure shown in the embodiment.

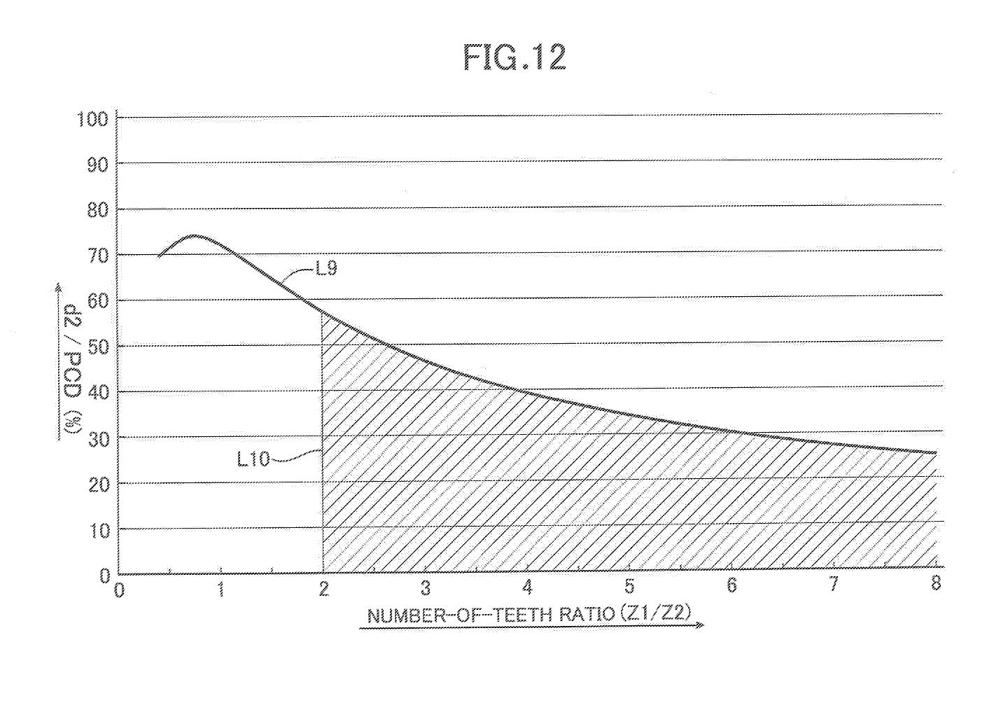

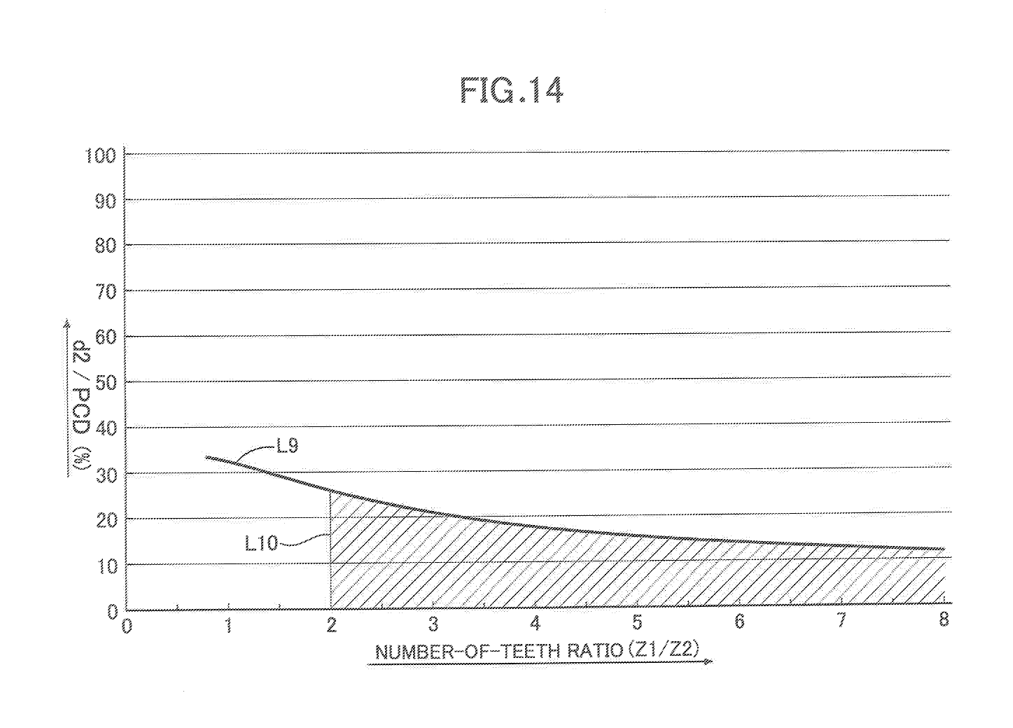

It should be noted that although the foregoing descriptions (the descriptions in connection with FIGS. 8, 10, 11 in particular) have been provided for the differential device in which the number Z2 of teeth of the pinion P is set at 10, the present invention is not limited to this. For example, when the number Z2 of teeth of the pinion P is set at 6, 12 and 20, too, the thinned differential device capable of achieving the above effects can be represented by Expression (13), as shown by hatched areas in FIGS. 12, 13 and 14. In other words, Expression (13) derived in the above-described manner is applicable regardless of the change in the number Z2 of teeth of the pinion P. For example, even when the number Z2 of teeth of the pinion P is set at 6, 12 and 20, the above effects can be obtained by setting the number Z1 of teeth of the side gear S, the number Z2 of teeth of the pinion P, the shaft diameter d2 of the pinion shaft PS and the pitch cone distance PCD such that Expression (13) is satisfied, like in the case where the number Z2 of teeth of the pinion P is set at 10.

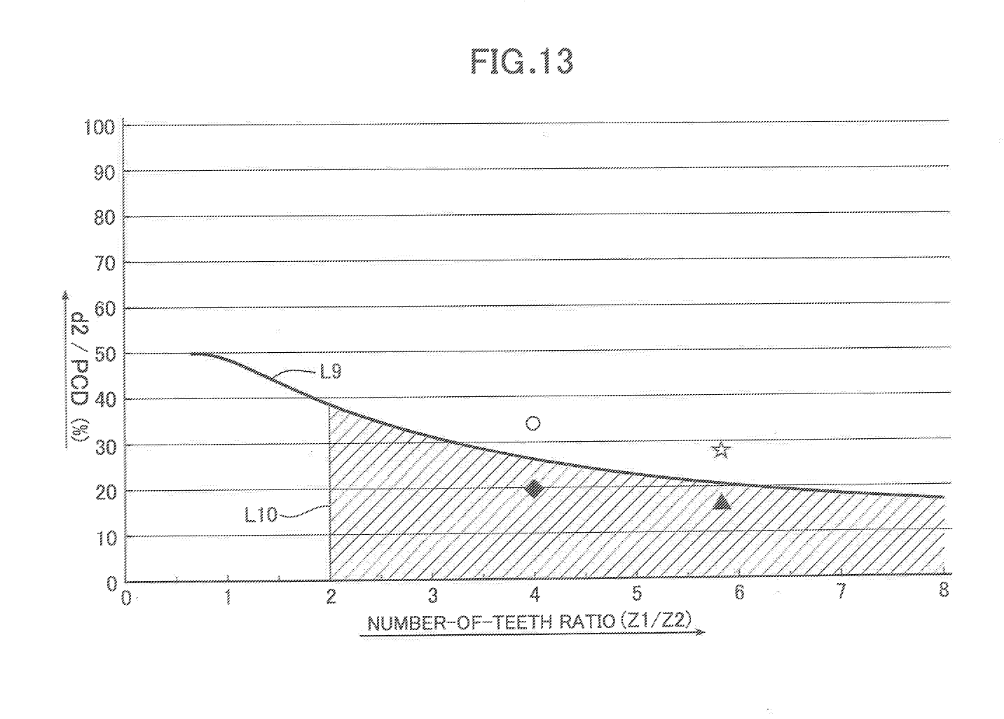

Furthermore, for reference, a black diamond in FIG. 13 represents an example where when the number Z2 of teeth of the pinion P is 12, the number-of-teeth ratio Z1/Z2 and d2/PCD are set at 48/12 and 20.00%, respectively, and a black triangle in FIG. 13 represents an example where when the number Z2 of teeth of the pinion P is 12, the number-of-teeth ratio Z1/Z2 and d2/PCD are set at 70/12 and 16.67%, respectively. A result of a simulation for strength analysis on these examples has confirmed that the gear strength equal to or greater than those of the conventional differential devices (more specifically, the gear strength equal to or greater than 87% of the gear strength of the reference differential device D′) were obtained. Moreover, these examples fall within the specific area, as shown in FIG. 13.

As comparative examples, let us show examples which do not fall within the specific area. A white star in FIG. 11 represents an example where when the number Z2 of teeth of the pinion P is for example 10, the number-of-teeth ratio Z1/Z2 and d2/PCD are set at 58/10 and 27.50%, respectively, and a white circle in FIG. 11 represents an example where when the number Z2 of teeth of the pinion P is for example 10, the number-of-teeth ratio Z1/Z2 and d2/PCD are set at 40/10 and 34.29%, respectively. A white star in FIG. 13 represents an example where when the number Z2 of teeth of the pinion P is for example 12, the number-of-teeth ratio Z1/Z2 and d2/PCD are set at 70/12 and 27.50%, respectively, and a white circle in FIG. 13 represents an example where when the number Z2 of teeth of the pinion P is for example 12, the number-of-teeth ratio Z1/Z2 and d2/PCD are set at 48/12 and 34.29%, respectively. A result of a simulation for strength analysis on these examples has confirmed that the gear strength equal to or greater than those of the conventional differential devices (more specifically, the gear strength equal to or greater than 87% of the gear strength of the reference differential device D′) were not obtained. In other words, the above effects cannot be obtained from the examples which do not fall within the specific area.

Although the embodiments of the present invention have been described, the present invention is not limited to the foregoing embodiments. Various design changes may be made to the present invention within a scope not departing from the gist of the present invention.

For example, although the foregoing embodiment has been shown in which the lubricant oil grooves 23 are the straight grooves extending from the inner ends of the lubricant oil passages 22 toward the outsides of the side gears S in the radial directions of the side gears S (i.e., radially), the lubricant oil grooves of the present invention are not limited to those of the embodiment as long as the lubricant oil grooves each have a groove shape which enables the lubricant oil to be at least supplied smoothly from the lubricant oil passages 22 toward the tooth portions Sg of the side gear using the centrifugal force. Various modified embodiments are applicable to the lubricant oil grooves of the present invention. For example, the lubricant oil grooves of the present invention may be each formed from a groove at least partially curved, or from a straight groove inclining oblique to the radial direction of the side gear S. Incidentally, no matter what form the lubricant oil grooves may have, it is desirable that the lubricant oil grooves 23 each have one end portion connected (disposed close) to the inner end of the lubricant oil passage 22, and the other end portion connected (disposed close) to the tooth portion Sg of the side gear.

Furthermore, although the foregoing embodiment has been shown in which the lubricant oil randomly scattered inside the transmission case 1 naturally flows into the lubricant oil passages 22, lubricant oil splashed in specific directions inside the transmission case 1 in response to the rotation of the differential device D, or lubricant oil dropped from a ceiling portion onto specific parts of the transmission case 1 may be designed to actively flow into the lubricant oil passages 22. Otherwise, lubricant oil may be forced to flow into the lubricant oil passages 22 using a lubricant oil pump.

In addition, although the foregoing embodiment where the lightening portions 8 are provided to the side wall portion Cs of at least one of the left and right cover portions C, C′ has been shown, the lightening portions 8 may be not formed in the side wall portions Cs of both of the left and right cover portions C, C′ so that the side wall portions Cs cover the entire back surfaces of the corresponding side gears S.

Furthermore, although the foregoing embodiment where the input member I integrally includes the input tooth portion Ig has been shown, a ring gear which is formed separately from the input member I may be fixed to the input member I later. Moreover, the input member of the present invention may have a structure which includes neither the input tooth portion Ig nor the ring gear. For example, the input member I may be operatively connected to a drive member (for example, an output member of a planetary gear mechanism or a reduction gear mechanism, a driven wheel of an endless transmission belt-type transmission mechanism and the like) situated more upstream than the input member I on the power transmission passage so that the rotational driving force is inputted into the input member I.

Moreover, the foregoing embodiment where the back surfaces of the pair of side gears S are covered with the pair of cover portions C, C′ has been shown, however, in the present invention, the back surface of only one side gear S may be provided with the cover portion. In this case, for example, the drive member situated more upstream than the input member I may be disposed on the side gear side provided with no cover portion so that the drive member and the input member are operatively connected to each other on the side gear side provided with no cover portion.

Besides, although the foregoing embodiment has shown the example where the lubricant oil passages 22 formed in the shaft portion Sj of each side gear S and configured to guide the lubricant oil from the outer end portion to the inner end portion of the shaft portion Sj in the axial direction are formed by lacking some of the teeth of the inner peripheral spline 21 of the shaft portion Sj, the lubricant oil passages of the present invention are not limited to those of the foregoing embodiment. The lubricant oil passages of the present invention may be formed of, for example, spiral grooves to be provided in the inner peripheral surface of the shaft portion Sj of each side gear S.

In addition, although the foregoing embodiment has been shown in which the differential device D allows the difference in rotation between the left and right axles, the differential device of the present invention may be carried out as a center differential configured to absorb the difference in rotation between front wheels and rear wheels.

What is claimed is:

1. A differential device which distributively transmits rotational force of an input member to a pair of output shafts via a pair of side gears, the input member retaining a pinion support portion that supports a pinion and being rotatable together with the pinion support portion, wherein
the pair of side gears each include
a tooth portion provided in an outer peripheral portion and meshing with the pinion, and
a shaft portion provided in an inner peripheral portion and connected to the corresponding output shaft, and
at least one of the side gears includes
a lubricant oil passage in the shaft portion, the lubricant oil passage guiding lubricant oil from an outer end portion to an inner end portion in an axial direction of the shaft portion, and
a lubricant oil groove in an inner side surface facing the other side gear, the lubricant oil groove being configured to supply the lubricant oil from the lubricant oil passage to the tooth portion side.

2. The differential device according to claim 1, wherein
the pair of side gears each include
a flat intermediate wall portion integrally connecting the shaft portion and the tooth portion separated outward from the shaft portion in a radial direction of the input member, and
at least one of the side gears includes the lubricant oil groove in an inner side surface of the intermediate wall portion.

3. The differential device according to claim 1, wherein
the lubricant oil groove includes a straight groove portion extending straight, and a guide groove portion continuous to an outer end of the straight groove portion in the radial direction, and
a bottom surface of the guide groove portion inclines relative to a bottom surface of the straight groove portion.

4. The differential device according to claim 2, wherein
the lubricant oil groove includes a straight groove portion extending straight, and a guide groove portion continuous to an outer end of the straight groove portion in the radial direction, and
a bottom surface of the guide groove portion inclines relative to a bottom surface of the straight groove portion.

5. The differential device according to claim 3, wherein
the pinion support portion includes a cutout surface in an outer peripheral surface, at least part of the cutout surface facing an inner peripheral surface of the pinion, and
the guide groove portion and the part of the cutout surface are situated on a same circumference around an axis of the output shafts as seen in a projection plane orthogonal to the axis.

6. The differential device according to claim 4, wherein
the pinion support portion includes a cutout surface in an outer peripheral surface, at least part of the cutout surface facing an inner peripheral surface of the pinion, and
the guide groove portion and the part of the cutout surface are situated on a same circumference around an axis of the output shafts as seen in a projection plane orthogonal to the axis.

7. A differential device which distributively transmits rotational force of an input member to a pair of output shafts via a pair of output gears, the input member retaining a differential gear support portion that supports a differential gear and being rotatable together with the differential gear support portion, wherein
the pair of output gears each include
a tooth portion provided in an outer peripheral portion and meshing with the differential gear, and
a shaft portion provided in an inner peripheral portion and connected to the corresponding output shaft, and
at least one of the output gears includes
a lubricant oil passage in the shaft portion, the lubricant oil passage guiding lubricant oil from an outer end portion to an inner end portion in an axial direction of the shaft portion, and
a lubricant oil groove in an inner side surface facing the other output gear, the lubricant oil groove being configured to supply the lubricant oil from the lubricant oil passage to the tooth portion side,
wherein
$$d 2 / P C D ≦ 3.36 \cdot {( \frac{1}{z 1} )}^{\frac{2}{3}} \cdot sin ( {tan}^{- 1} \frac{z 1}{z 2} )$$
is satisfied, and
Z1/Z2>2 is satisfied, where Z1, Z2, d2 and PCD denote the number of teeth of each of the output gears, the number of teeth of the differential gear, a diameter of the differential gear support portion and a pitch cone distance, respectively.

8. The differential device according to claim 7, wherein
Z1/Z2≧4 is satisfied.

9. The differential device according to claim 7, wherein
Z1/Z2≧5.8 is satisfied.
